(19) United States
(12) Patent Application Publication
(10) Pub. No.: US 2001/0012784 A1
(43) Pub. Date: Aug. 9, 2001

(54) ACOUSTIC SUPPORT SYSTEM

(76) Inventor: RENE LAZECKI, SAX (CH)

Correspondence Address: OSTROLENK FABER, GERB & SOFFEN LLP, 1180 AVENUE OF THE AMERICAS, NEW YORK, NY, 100368403

(21) Appl. No.: 09/006,063

(22) Filed: Jan. 12, 1998

(51) Int. Cl. H04B 7/00

(52) U.S. Cl. 455/517; 455/39; 455/500

(57) ABSTRACT

An acoustic support system comprising a number of mobile units each including a electronic control unit, a memory for data representing acoustic signals, a reception unit for receiving control data, a transformation unit for transforming the part of data selected by the control unit from the data stored in the memory into acoustic signals, and a sound unit for playing back the acoustic signals. Further it is provided for a central unit including a control unit for generating control data and a broadcasting unit for transmitting control data to selected mobile units. The mobile units with the acoustic signals stored therein can individually be selected and controlled to allow realistic acoustic simulation of events. The system is easy to handle and can be used repeatedly and has a low price.

### BACKGROUND OF THE INVENTION

The invention relates to an acoustic support system as used e.g. by armies during combat exercises to render the exercise as realistic as possible for each participant. Certain combat situations, as e.g. the use of chemical weapons, the overfly by planes, the explosion of mines, artillery, tank, mortar or hand grenades can only be simulated by using acoustic support systems.

There are known acoustic support systems in which pyrotechnical firecrackers are used. These known systems present, however, the disadvantage that they are very unhandy and extremely dangerous. A person present in the very vicinity of an exploding firecracker can afterward suffer from severe cochlea or even loss of hearing.

### SUMMARY OF THE INVENTION

It is the goal of the present invention to create an acoustic support system, which is easy to use and can serve several times, and which is cheap.

According to the invention this goal is achieved by an acoustic support system as defined in claim 1. The individually controllable mobile units with the acoustic signals stored therein allow realistic acoustic simulations.

Further advantageous embodiments are defined in the dependent claims.

### BRIEF DESCRIPTION OF THE DRAWINGS

Hereinbelow and based on the drawing some examples of embodiments of the invention are described in more details.

In the drawing

FIG. 1 schematically shows the concept of the acoustic support system according to the invention.

### DETAILED DESCRIPTION OF THE INVENTION

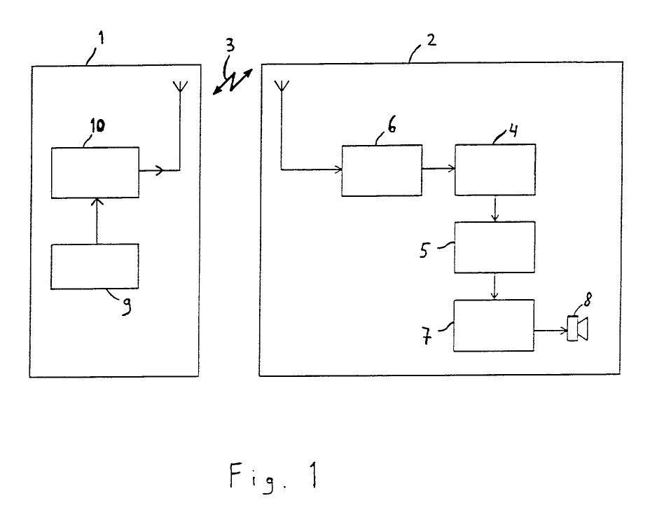

FIG. 1 schematically shows a central unit 1 and a mobile unit 2 of an acoustic support system according to the invention. The symbol and reference number 3 indicates that between the central unit 1 and the mobile unit 2 their exist a radio link. It is, however, also possible that the system includes other linking means for the transfer of signals, as e.g. optical fiber links. The signals used in the system are preferably electromagnetic signals, which, as an example, can be transmitted by radio links over certain parts of the transmission distance, and through optical fiber links over other parts of the transmission distance. In the following description of an embodiment of the invention and in view to simplify, the signals are considered to be radio signals.

Each active participant of an exercise can be a user of the system and carries a mobile unit 2. The central unit 1 is, e.g. located in a control room close to the place where the exercise takes place. Each of the mobile units 2 include an electronic control unit 4, an electronic memory 5 for storing data representing acoustic signals, a reception unit 6 for receiving control data, a transformation unit 7 for transforming into acoustic signals the data selected by the control unit 4 from the stored data, and a sound unit 8 to play back the acoustic signals. The control unit 4 is connected to the memory 5 and the reception unit 6. The transformation unit 7 is connected to the memory 5 and the sound unit 8. The central unit 1 includes a control unit 9 for generating control data and a broadcast unit 10 for the transmission of control data to a number of selected mobile units 2.

The control unit 9 of the central unit 1 is designed in such a way that it can select a certain number of mobile units 2 and generate actual control data for each such selected mobile unit 2 in dependence of its actual position and the fictive actual position of an event to be simulated. For the detection of the positions of the mobile units 2 a navigation system can be used which will feed the control unit 9 with position data. For simulating an event, as e.g. a mine explosion, the control unit 9 is feed with the coordinates of the place at which the fictive event takes place. The control unit 9 on the central unit 1 then generates control data for the mobile units 2 present in the closer vicinity of the fictive place where the explosion takes place.

The generated control data are then transmitted to the broadcast unit 10, which transmits them by radio to the reception units 6 of the selected mobile units 2. There, the control data are transmitted to the control unit 4, which will select such parts of the data stored in the memory 5, which correspond to the event to be simulated. The stored data represent acoustic signals as, e.g. noise, spoken words or complete sentences. The selected parts of the data stored in memory 5 are transmitted to the transformation unit 7, which will transform the data into acoustic signals. The sound unit 8 is then feed with these acoustic signals and plays them back.

The sound unit 8 includes two loudspeakers, which are positioned close to the ears of a user in such a way that the noise of the surrounding is not reduced considerably. The memory 5 is preferably an electronic digital memory, as e.g. an integrated semi-conductor memory (Read-Only-Memory). The data stored therein may be analog or digital or combined analog-digital data. The transformation unit 7 is an integrated semi-conductor circuit, which is able to transform digitally stored data into understandable words, sentences or noise. The data stored in memory 5 are specifically and individually selectable by means of the control unit 4. In this way it is possible to recall from the data stored in memory 5 a noise corresponding to the event to be simulated. That noise is then transmitted to the sound unit 8 to be played back. It is also possible to store orders as words or sentences, which can individually be played back to each participant, if necessary.

In an embodiment of the invention the control unit 9 of the central unit 1 is capable to generate actual control data for a selected mobile unit 2 in dependence from a fictive actual moving direction of the event to be simulated. Such control data allow to control the loudness of the played back signals as a function of the actual position of the selected mobile unit 2 and the actual fictive position of the event to be simulated. So, e.g., an overflying plane can be simulated by a corresponding noise getting louder and quieter again.

In a further embodiment of the acoustic support system according to the invention the mobile units 2 are equipped with (not shown) means to detect the orientation of the respective user and to transmit the corresponding data to the central unit 1. By means of a compass and a broadcast unit the actual position of a participant can be determined and transmitted to the central unit 1. The control unit 9 of the central unit 1 is able to generate control data in such a way that the sound unit 8 plays back a stereophonic signal for a selected mobile unit 2 which is a function of the actual position of the mobile unit 2, the fictive actual position of the event to be simulated and the orientation of the selected mobile unit 2.

The central unit 1 is able to sequentially select and control several mobile units 2 and also repeatedly select and control the mobile units 2. Thanks to the acoustic support system according to the invention it is possible to improve remarkably and at a low price the quality of the events to be simulated.

1. An acoustic support system, wherein the system comprises a certain number of mobile units that each include an electronic control unit, a memory for data representing acoustic signals, a reception unit for receiving control data, a transformation unit for transforming the part of data selected by the control unit from the data stored in the memory into acoustic signals, and a sound unit for playing back the acoustic signals, the system further comprising a central unit for generating control data and a broadcast unit for transmitting the control data to a number of selected mobile units.

2. An acoustic support system according to claim 1, wherein each user of the system carries one mobile unit.

3. An acoustic support system according to claim 1, wherein the control unit of the central unit is able to generate actual control data for a selected mobile unit as a function of the actual position of the selected mobile unit and the fictive actual position of the event to be simulated.

4. An acoustic support system according to claim 3, wherein the control unit of the central unit is able to take into account a fictive movement of the event to be simulated for the generation of the control data.

5. An acoustic support system according to claim 1, wherein the sound unit includes two loudspeakers.

6. An acoustic support system according to claim 5, wherein the loudspeakers are designed to be placed close to the ears of a participant without considerably reducing the surrounding noise.

7. An acoustic support system according to claim 3, wherein the control unit of the central unit is able to generate control data for a selected mobile unit allowing to control the actual loudness of the acoustic signals to be played back as a function of the actual position of the selected unit and the fictive actual position of the event to be simulated.

8. An acoustic support system according to claim 1, wherein the mobile units include means for detecting the orientation of the respective user and for transmitting corresponding data to the central unit.

9. An acoustic support system according to claim 8, wherein the control unit of the central unit is able to generate control data for a selected mobile unit that allow to play back a stereophonic signal which is a function of the actual position of the selected mobile unit and the fictive actual position of the event to be simulated.
